(19) United States
(12) Patent Application Publication
(10) Pub. No.: US 2012/0231401 A1
(43) Pub. Date: Sep. 13, 2012

(54) INTERCONNECTABLE CANDLE HOLDER

(76) Inventor: Huang-Hsi HSU, Taipei (TW)

(21) Appl. No.: 13/399,305

(22) Filed: Feb. 17, 2012

(30) Foreign Application Priority Data
Mar. 7, 2011 (TW) 100107521

(51) Int. Cl. F21V 35/00

(52) U.S. Cl. 431/289

(57) ABSTRACT

The present invention is to provide an interconnectable candle holder, which has a top surface formed with an opening extending inward along a longitudinal direction of the interconnectable candle holder to form a receiving space whose configuration allows a candle to be inserted into the receiving space, a lateral surface adjacent to the top surface and formed with a groove extending along the longitudinal direction to the bottom surface of the interconnectable candle holder and being in communication with the receiving space, and another lateral surface adjacent to the top surface and formed with a ridge extending along the longitudinal direction to the bottom surface and corresponding in configuration to the groove. Thus, a plurality of such candle holders having different heights can be connected with each other and jointly form a very stable supporting surface that effectively prevents the candle holders from toppling.

### FIELD OF THE INVENTION

The present invention relates to a candle holder, more particularly to an interconnectable candle holder, which has a top surface formed with an opening for receiving a candle, a lateral surface formed with a groove, and another lateral surface formed with a ridge corresponding in configuration to the groove, so as to allow a plurality of such candle holders having different heights to be connected with each other and jointly form a very stable supporting surface that effectively prevents the candle holders from toppling.

### BACKGROUND OF THE INVENTION

Candles, which in the past were mainly used for illumination, have been gradually replaced by electric lamps since the invention of electric lighting. Nowadays, candles serve as an emergency light source during power outage, among many other uses. For example, the convention or custom of candle burning is observed on special holidays or in certain religious events, gatherings, or mourning ceremonies. In the Chinese society, red candles are burned in traditional wedding ceremonies to mark the felicity of the occasion, and white candles are burned at funerals. Hence, although the role of candles in the field of lighting has been superseded by electric lamps, candles are still widely used in other fields.

Recently, as the demand for higher living quality rises with the growth of personal wealth, many individuals or companies use candle light to decorate their homes or business places. It is now common practice for an individual or company (hereinafter generally referred to as “user”) to put a candle holder in a proper place (e.g., on a tabletop) in a domestic or commercial environment and set a candle in the candle holder so that when the candle is lit, a different ambience is created to add to the delight of life. Aside from ordinary candles, essential oil candles which are made with plant-based essential oils extracted from flowers, fruit, or herbs are available for aromatherapy, which is intended to relax both body and mind.

Nevertheless, a lit candle on a candle holder may cause fire accidents when the candle holder is inadvertently knocked over by a child or pet (e.g., a cat or dog) and ends up falling or rolling to the vicinity of a carpet or other inflammable object, thus leading to loss of property or even human lives. Moreover, the conventional candle holders are configured only for supporting and holding candles and lack variation in shape. It is also impossible for a user to connect several candle holders together in different arrangements in coping with the interior design of a domestic or business environment. Therefore, the conventional candle holders leave much room for improvement in practical use.

The issue to be addressed by the present invention is to overcome the drawbacks of the existing candle holders and design a candle holder which can be stably placed to increase safety in use, preventing fire accidents otherwise attributable to the toppling of the candle holder, and which allows a plurality of such candle holders to be connected to one another, thus bringing more variety and fun to the arrangement of such candle holders.

### BRIEF SUMMARY OF THE INVENTION

In view of the various shortcomings of the conventional candle holders, the inventor of the present invention conducted extensive research and experiment and finally succeeded in developing an interconnectable candle holder as disclosed herein. The disclosed candle holder provides more fun and variety in use than its prior art counterparts while ensuring stability and safety in use. A user can use the disclosed candle holder safely in business place decoration as well as in home decoration.

It is an object of the present invention to provide an interconnectable candle holder. The top surface of the interconnectable candle holder is formed with an opening. The opening extends inward along the longitudinal direction of the interconnectable candle holder to form a receiving space whose configuration allows a candle to be inserted into the receiving space. A lateral surface of the interconnectable candle holder that is adjacent to the top surface is formed with a groove. The groove extends along the longitudinal direction of the interconnectable candle holder to the bottom surface of the interconnectable candle holder and is in communication with the receiving space. The interconnectable candle holder forms a convex surface corresponding in position to the groove. Another lateral surface of the interconnectable candle holder that is adjacent to the top surface is formed with a ridge. The ridge extends along the longitudinal direction of the interconnectable candle holder to the bottom surface of the interconnectable candle holder and has an end surface facing away from the interconnectable candle holder and concavely provided with a concave surface. The ridge corresponds in configuration to the groove while the concave surface corresponds in configuration to the convex surface. To connect a plurality of such candle holders having different heights, the ridge of one interconnectable candle holder is engaged with the groove of another interconnectable candle holder along the longitudinal direction. The concave surface and the convex surface of each two adjoining interconnectable candle holders lie closely against each other such that not only are the two adjoining interconnectable candle holders stably connected, but also the complementary configurations of the concave surface and the convex surface ensure that the receiving space at the top surface of each of the two adjoining interconnectable candle holders remains a standard space for receiving a candle. Furthermore, the bottom surfaces of the plural interconnectable candle holders jointly form a very stable supporting surface that effectively prevents the candle holders from toppling. Thus, the stability and safety of the candle holders in use are guaranteed while fun and variety are added to the use of the candle holders.

Another object of the present invention is to provide the foregoing interconnectable candle holder, wherein the interconnectable candle holder is made of glass so as for candle light to take advantage of the light-permeability of the interconnectable candle holder and thereby produce rich light and shadow effects.

Still another object of the present invention is to provide the foregoing interconnectable candle holder, wherein the opening is circular. This allows a user to place a candle of a circular cross section in the receiving space.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a perspective view of the first preferred embodiment of the present invention;

FIG. 2 is a perspective view of the second preferred embodiment of the present invention; and

FIG. 3 is a perspective view of another preferred embodiment of the present invention.

### DETAILED DESCRIPTION OF THE INVENTION

The inventor of the present invention has long been engaged in the development and design of candle holders. In the process, the inventor has found that the conventional candle holders tend to be knocked over during use and therefore raise safety issues. Moreover, the conventional candle holders are mostly of monotonous shapes and are not adaptive to the environment where they are used. Despite research and development efforts made to solve the aforementioned problems, an ideal solution has yet to be found. In consideration of this, the inventor came up with improving the candle holder structure so that a plurality of candle holders can be connected together via their own structures, with a stable supporting surface formed by the bottom surfaces of the plural candle holders to prevent the candle holders from toppling and thus increase their safety in use.

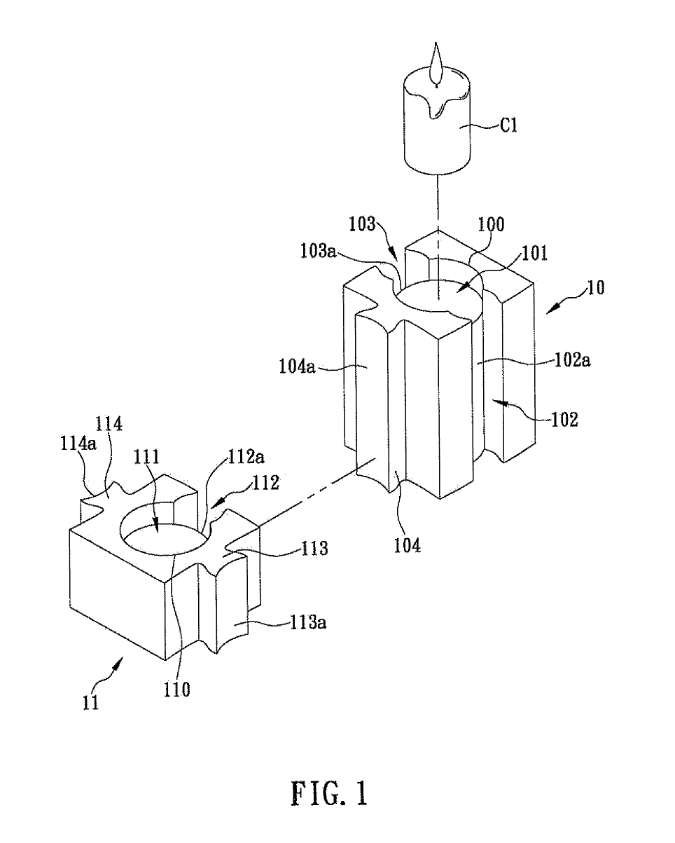

The present invention discloses an interconnectable candle holder. Please refer to FIG. 1 for a preferred embodiment of the present invention, in which two interconnectable candle holders 10 and 11 serve to demonstrate the main structure and concept of the present invention. To distinguish the two interconnectable candle holders 10 and 11 in FIG. 1, the interconnectable candle holders 10 and 11 and their structural features are given different reference numerals. Further, the interconnectable candle holder 10 in the upper right position of FIG. 1 is hereinafter referred to as the first interconnectable candle holder 10, and the interconnectable candle holder 11 in the lower left position of FIG. 1 as the second interconnectable candle holder 11. As shown in FIG. 1, the top surface of the first interconnectable candle holder 10 is formed with an opening 100. The opening 100 extends into the first interconnectable candle holder 10 along the longitudinal direction thereof to form a receiving space 101. In this preferred embodiment, the opening 100 is a circular opening; therefore, the configuration of the receiving space 101 allows a candle C1 of a circular cross section to be inserted into the receiving space 101. Nevertheless, the configurations of the opening 100 and hence of the receiving space 101 are not limited to the above. It should be pointed out that the opening 100 is illustrated in the accompanying drawings as circular by way of example only, so that a person skilled in the art can clearly understand the technical features of the present invention; in practice, however, the present invention imposes no limitations in this regard. Those who intend to design and manufacture the first interconnectable candle holder 10 in accordance with the present invention may change the shape of the opening 100 as needed. For instance, the circular opening 100 may be changed into an oval opening, and the intended effects of the present invention can still be achieved. All changes readily conceivable by a person skilled in the art should fall within the scope of the present invention.

Referring again to FIG. 1, two opposite lateral surfaces of the first interconnectable candle holder 10 that are adjacent to the top surface are formed with grooves 102 and 103 respectively. Each of the grooves 102 and 103 extends along the longitudinal direction of the first interconnectable candle holder 10 to the bottom surface of the first interconnectable candle holder 10. In addition, the grooves 102 and 103 communicate with the receiving space 101 respectively. The first interconnectable candle holder 10 further forms a convex surface 102a corresponding in position to the groove 102, and a convex surface 103a corresponding in position to the groove 103. Another lateral surface of the first interconnectable candle holder 10 that is adjacent to the top surface is protrudingly provided with a ridge 104. The ridge 104 extends along the longitudinal direction of the first interconnectable candle holder 10 to the bottom surface of the first interconnectable candle holder 10. Also, the ridge 104 has an end surface facing away from the first interconnectable candle holder 10 and concavely provided with a concave surface 104a. The configuration of the ridge 104 corresponds to the configuration of each of the grooves 102 and 103, and the configuration of the concave surface 104a corresponds to the configuration of each of the convex surfaces 102a and 103a.

Likewise, as shown in FIG. 1, the top surface of the second interconnectable candle holder 11 is formed with an opening 110. The opening 110 extends into the second interconnectable candle holder 11 along the longitudinal direction thereof to form a receiving space 111. A lateral surface of the second interconnectable candle holder 11 that is adjacent to the top surface is formed with a groove 112. The groove 112 extends along the longitudinal direction of the second interconnectable candle holder 11 to the bottom surface of the second interconnectable candle holder 11 and communicates with the receiving space 111. The second interconnectable candle holder 11 forms a convex surface 112a corresponding in position to the groove 112. Besides, two opposite lateral surfaces of the second interconnectable candle holder 11 that are adjacent to the top surface are respectively and protrudingly provided with ridges 113 and 114. Each of the ridges 113 and 114 extends along the longitudinal direction of the second interconnectable candle holder 11 to the bottom surface of the second interconnectable candle holder 11. Moreover, each of the ridges 113 and 114 has an end surface that faces away from the second interconnectable candle holder 11, and these end surfaces of the ridges 113 and 114 are respectively and concavely provided with concave surfaces 113a and 114a. Besides, each of the ridges 113 and 114 corresponds in configuration to the groove 112. Each of the ridges 113 and 114 also corresponds in configuration to the grooves 102 and 103. In addition, each of the concave surfaces 113a and 114a corresponds in configuration to the convex surface 112a and also to the convex surfaces 102a and 103a. In this preferred embodiment, both the interconnectable candle holders 10 and 11 are made of glass, but the present invention imposes no limitations in this respect. Those who intend to design and manufacture the interconnectable candle holders 10 and 11 in accordance with the present invention may use other materials as well. For example, the interconnectable candle holders 10 and 11 may be made of a high temperature-resistant plastic material, wood, metal (e.g., stainless steel or aluminum) by injection molding, machining, molding, or forging. The major concept of the present invention consists in the structure and interconnectability of the interconnectable candle holders 10 and 11. All variations easily conceivable by a person skilled in the art should fall within the scope of the present invention.

In the first preferred embodiment described above, the ridge 104 of the first interconnectable candle holder 10 is engageable with the groove 112 of the second interconnectable candle holder 11 such that the concave surface 104a lies closely against the convex surface 112a. Thus, not only can the interconnectable candle holders 10 and 11 be stably connected together, but also the complementary configurations of the concave surface 104a and the convex surface 112a ensure that each of the receiving spaces 101 and 111 on the top surfaces of the interconnectable candle holders 10 and 11 remains a standard space for receiving a candle C1. The technical features of the first preferred embodiment are such that, once the first intereonnectable candle holder 10 and the second interconnectable candle holder 11 are put together, the candle C1 can be placed in the receiving space 101 of the first interconnectable candle holder 10, and due to the fact that the interconnectable candle holders 10 and 11 are now connected to each other, their bottom surfaces form a very stable supporting surface. Therefore, the interconnectable candle holders 10 and 11, when connected together, will not be knocked over even if they are inadvertently hit by a child or pet. Consequently, the stability and safety of the candle holders in use are effectively ensured.

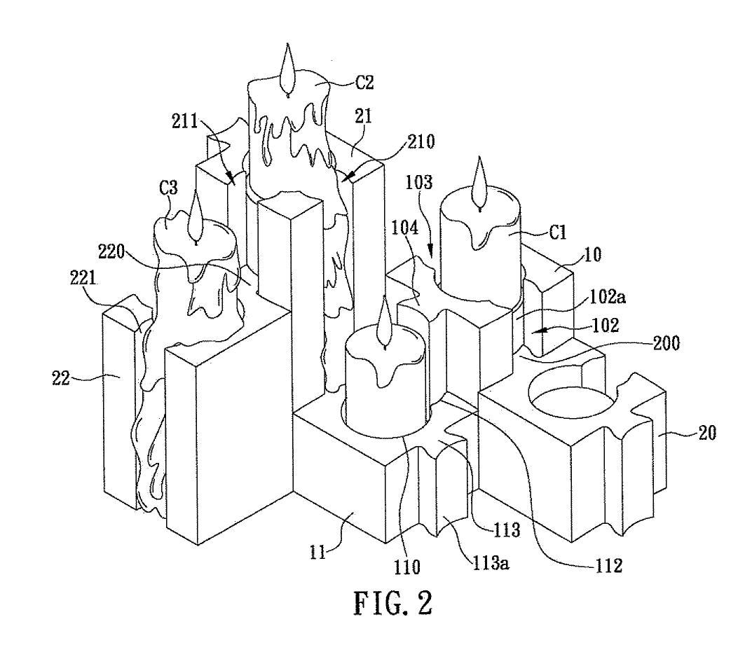

Referring to FIG. 2, the second preferred embodiment of the present invention includes a third interconnectable candle holder 20, a fourth interconnectable candle holder 21, and a fifth interconnectable candle holder 22, in addition to the aforesaid first and second interconnectable candle holders 10 and 11. In the second preferred embodiment, the interconnectable candle holders 20, 21, and 22 are all made of glass. A candle C2 is received in the receiving space of the fourth interconnectable candle holder 21, and a candle C3 is received in the receiving space of the fifth interconnectable candle holder 22. The groove 102 of the first interconnectable candle holder 10 is engaged with the ridge 200 of the third interconnectable candle holder 20 such that the first and the third interconnectable candle holders 10 and 20 are connected as a whole. The ridge 114 of the second interconnectable candle holder 11 (see FIG. 1) is engaged with the groove 210 of the fourth interconnectable candle holder 21 such that the second and the fourth interconnectable candle holders 11 and 21 are connected together. Also, the other groove 211 of the fourth interconnectable candle holder 21 is engaged with the ridge 220 of the fifth interconnectable candle holder 22 such that the fourth and the fifth interconnectable candle holders 21 and 22 are connected to each other. In the second preferred embodiment, the interconnectable candle holders 10, 11, 20, 21, and 22 are interconnected to form a single unit. As such, the bottom surfaces of the interconnectable candle holders 10, 11, 20, 21, and 22 jointly form a very stable supporting surface to effectively prevent fire accidents which may otherwise result from toppling of the candle holders.

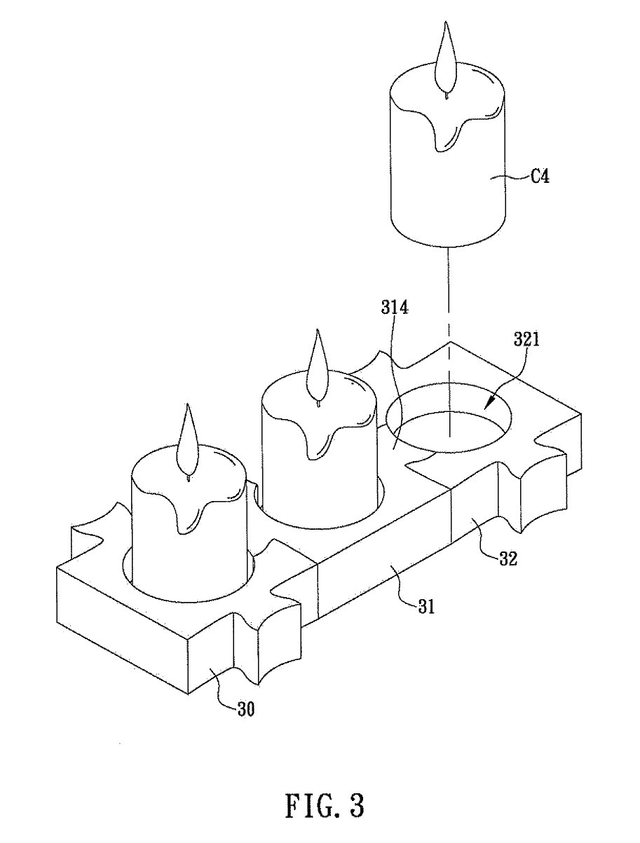

Those who intend to design and manufacture the interconnectable candle holders 10, 11, 20, 21, and 22 in accordance with the present invention may design the interconnectable candle holders 10, 11, 20, 21, and 22 in different heights (as shown in FIG. 2) and use glass of different colors to make the interconnectable candle holders 10, 11, 20, 21, and 22. This allows a user to arrange and connect the interconnectable candle holders 10, 11, 20, 21, and 22 of different heights in the desired manner so that rich light and shadow effects can be produced with the varied heights of candle light and of the interconnectable candle holders 10, 11, 20, 21, and 22 and with the light-permeability and colors of the interconnectable candle holders 10, 11, 20, 21, and 22. Not only that, while the candle C2 is burning, its molten wax flows along the outer surface of the candle C2, runs downward through the groove 210, and then spreads onto the top surface of the adjacent and lower interconnectable candle holder 11. Similarly, the molten wax of the candle C3 flows through the groove 221. Once the molten wax flowing from the interconnectable candle holder 21 to the interconnectable candle holder 11 solidifies, the solidified wax resembles a frozen waterfall in appearance, which adds to the delicate ambience of candle burning. Besides, referring to FIG. 3, the technical features of the present invention allow assembly of a plurality of interconnectable candle holders 30, 31, and 32 that are of the same height. As shown in FIG. 3, the space defined by the receiving space 321 and the concave surface of the corresponding ridge 314 can be used to receive a candle C4 inserted therein. Hence, based on the concept of the present invention, interconnectable candle holders of various sizes can be designed to bring more flexibility to the arrangement and connection of such candle holders.

While the invention herein disclosed has been described by means of specific embodiments, numerous modifications and variations could be made thereto by those skilled in the art without departing from the scope of the invention set forth in the claims.

What is claimed is:

1. An interconnectable candle holder, having a top surface formed with an opening, the opening extending inward along a longitudinal direction of the interconnectable candle holder to form a receiving space, the receiving space being configured for allowing insertion of a candle into the receiving space, the interconnectable candle holder having a lateral surface which is adjacent to the top surface and is formed with a groove, the groove extending along the longitudinal direction of the interconnectable candle holder to a bottom surface of the interconnectable candle holder and communicating with the receiving space, the interconnectable candle holder forming a convex surface corresponding in position to the groove, the interconnectable candle holder further having a lateral surface which is adjacent to the top surface and is formed with a ridge, the ridge extending along the longitudinal direction of the interconnectable candle holder to the bottom surface of the interconnectable candle holder, the ridge having an end surface which faces away from the interconnectable candle holder and is concavely provided with a concave surface, the ridge corresponding in configuration to the groove, the concave surface corresponding in configuration to the convex surface, wherein when a first said interconnectable candle holder is connected to a second said interconnectable candle holder having a same height as the first interconnectable candle holder by the groove of the first interconnectable candle holder and the ridge of the second interconnectable candle holder, a space into which the candle is still insertable is defined by the receiving space of the first interconnectable candle holder and the concave surface of the ridge of the second interconnectable candle holder.

2. The interconnectable candle holder of claim 1, wherein the interconnectable candle holder is made of glass.

3. The interconnectable candle holder of claim 1, wherein the interconnectable candle holder is made of a high temperature-resistant plastic material.

4. The interconnectable candle holder of claim 1, wherein the interconnectable candle holder is made of metal.

5. The interconnectable candle holder of claim 2, wherein the opening, to which the receiving space corresponds in position, is of a circular shape or other shapes corresponding to the candle such that, when a first said interconnectable candle holder is connected to a second said interconnectable candle holder having a same height as the first interconnectable candle holder by the groove of the first interconnectable candle holder and the ridge of the second interconnectable candle holder, a space into which the candle is insertable is defined by the receiving space of the first interconnectable candle holder and the concave surface of the ridge of the second interconnectable candle holder.

6. The interconnectable candle holder of claim 3, wherein the opening, to which the receiving space corresponds in position, is of a circular shape or other shapes corresponding to the candle such that, when a first said interconnectable candle holder is connected to a second said interconnectable candle holder having a same height as the first interconnectable candle holder by the groove of the first interconnectable candle holder and the ridge of the second interconnectable candle holder, a space into which the candle is insertable is defined by the receiving space of the first interconnectable candle holder and the concave surface of the ridge of the second interconnectable candle holder 5.

7. The interconnectable candle holder of claim 4, wherein the opening, to which the receiving space corresponds in position, is of a circular shape or other shapes corresponding to the candle such that, when a first said interconnectable candle holder is connected to a second said interconnectable candle holder having a same height as the first interconnectable candle holder by the groove of the first interconnectable candle holder and the ridge of the second interconnectable candle holder, a space into which the candle is insertable is defined by the receiving space of the first interconnectable candle holder and the concave surface of the ridge of the second interconnectable candle holder
